(19) United States
(12) Patent Application Publication
(10) Pub. No.: US 2013/0096953 A1
(43) Pub. Date: Apr. 18, 2013

(54) MEDICATION COMPLIANCE SYSTEM AND METHOD

(71) Applicants: Barry Beverly, Round Rock, TX (US); Scott Collins, Austin, TX (US)

(72) Inventors: Barry Beverly, Round Rock, TX (US); Scott Collins, Austin, TX (US)

(73) Assignee: Innovate Wireless Health, Inc., Round Rock, TX (US)

(21) Appl. No.: 13/806,592

(22) PCT Filed: Jun. 24, 2011
(86) PCT No.: PCT/US11/41885

§ 371 Date: Dec. 21, 2012

Related U.S. Application Data
(60) Provisional application No. 61/358,561, filed on Jun. 25, 2010.

(51) Int. Cl. G06F 19/00

(52) U.S. Cl. CPC G06F 19/3418
USPC 705/3

(57) ABSTRACT

A system which implements a preferred embodiment of the present invention includes a means for monitoring a patient's medication compliance. In one embodiment, the system will send a message to a patient's wireless device with a notification when it is time for the patient to administer a prescribed treatment. The system may also request that the patient or a caregiver reply with a confirmation that the treatment was completed. In one embodiment, the system may include sensors that detect whether a prescribed treatment was completed. The system may also record information such as the time, date, and substance of the transmissions of the reminder messages and/or the receipts of the confirmation messages or sensor readings. In one embodiment, the system may also send alert messages if the system is unable to verify whether a patient has completed her prescribed treatment at a designated time.

### CROSS-REFERENCE TO RELATED APPLICATIONS

This non-provisional application claims priority based upon prior U.S. Provisional Patent Application Ser. No. 61/358,561 filed Jun. 25, 2010 in the name of Barry Beverly entitled “Medication Compliance System and Method,” the disclosure of which is incorporated herein by reference.

### BACKGROUND OF THE INVENTION

The present invention relates generally to patient healthcare and, more particularly, to medication compliance and monitoring systems.

Medication non-compliance or non-adherence generally refers to people who do not take their medications according to prescription. It can also include persons who fail to take their prescribe medication at all, fail to take the correct dose, fail to take their medication at the correct time, fail to fill or re-fill their prescription, and over or under medicating themselves. An estimated 4.5 billion prescriptions were written in 2008, of which sixty percent were not taken as prescribed. Eighty one percent of non-compliant patients state “forgetfulness” as the reason for failing to take their medication according to prescription. Noncompliance leads to an estimated 3.5 million hospital admissions annually and twenty three percent of nursing home admissions. The total cost attributed to medication non-compliance is $177 billion per year and an estimated 125,000 people die each year due to medication non-compliance.

Therefore, it can be appreciated that there is a significant need for an improved medication compliance system and method that can improve patient adherence with medications, reduce medical inefficiencies, retain the potentially lost revenue of retail pharmacies, reduce medical costs of insurers, and improve communication, improve visibility of medical caregivers to patients, and improve patient outcome. Embodiments of the present invention can provide these and other advantages, as will be apparent from the following description and accompanying figures.

### BRIEF SUMMARY OF THE INVENTION

A system which implements a preferred embodiment of the present invention includes a means for monitoring a patient's medication compliance. In one embodiment, the system will send a message to the patient's wireless device with a notification when it is time for the patient to administer a prescribed treatment. The system may also request that the patient or caregiver reply with a confirmation that the treatment was completed. In one embodiment, the system may include sensors that detect whether a prescribed treatment was completed. The system may also record information such as the time, date, and substance of the transmissions of the reminder messages and/or the receipts of the confirmation messages or sensor readings.

In one embodiment, the system may also send alert messages. For example, the system may send alert messages to a caregiver if the system is unable to verify whether a patient has completed her prescribed treatment at a designated time. The system may also alert a patient that it is time to refill a prescription.

In one embodiment, the system may also allow users to view subsets of recorded data. For example, a patient or caregiver may review a patient's medication compliance history over time. In addition, a pharmaceutical company or medical insurer may review the medication compliance history of a particular group of patients and/or for a particular medication.

### BRIEF DESCRIPTION OF THE DRAWINGS

FIG. 1A is a simplified illustration of a system that includes components to implement one embodiment of the present invention.

FIG. 1B is an illustration of communication means in one embodiment of the present invention.

FIG. 2 is a flowchart illustrating the operation of significant functions in one embodiment of the present invention.

FIG. 3A is an illustration of a first treatment reminder message on a smart phone in one embodiment of the present invention.

FIG. 3B is an illustration of a second treatment reminder message on a flip-styled mobile phone in one embodiment of the present invention.

FIG. 3C is an illustration of a third treatment reminder message on a smart phone in one embodiment of the present invention.

FIG. 3D is an illustration of a fourth treatment reminder message on a smart phone in one embodiment of the present invention.

FIG. 4 is an illustration of a treatment reminder message requesting that a patient enter a blood glucose level in one embodiment of the present invention.

FIG. 5 is an illustration of a sealed envelope containing medication in one embodiment of the present invention.

FIG. 6 is an example screen shot of a list of users in one embodiment of the present invention.

FIG. 7 is an example screen shot of a user input screen in one embodiment of the present invention.

FIG. 8 is an example screen shot of a user medication profile in one embodiment of the present invention.

FIG. 9 is an example screen shot showing a graph of a user's medication compliance over time in one embodiment of the present invention.

FIG. 10 is an example screen shot showing a graph of a patient group's medication compliance over time in one embodiment of the present invention.

FIG. 11 is an example screen shot showing a table of a patient group's medication compliance over time in one embodiment of the present invention.

FIG. 12 is an example screen shot showing a table of a patient group's missed doses over a 30 day period in one embodiment of the present invention.

FIG. 13 is an example screen shot showing a patient's medication compliance statistics in one embodiment of the present invention.

### DETAILED DESCRIPTION

One embodiment of the present invention comprises a system and method for monitoring a patient's medication compliance. In one embodiment, the system will send a message to the patient's wireless device with a notification when it is time for the patient to administer a prescribed treatment. The system may also request that the patient or caregiver reply with a confirmation that the treatment was completed. In one embodiment, the system may include sensors that detect whether a prescribed treatment was completed and notify the system. The system may also record information such as the time, date, and substance of the transmissions of the reminder messages and/or the receipts of the confirmation messages or sensor readings. In one embodiment, one patient enters the information. In another embodiment, data is transmitted from a wired or wireless sensor. Sensors can include glucose meters, a weight scale, A1C meter, or any other consumer medical device or prescribed medical device.

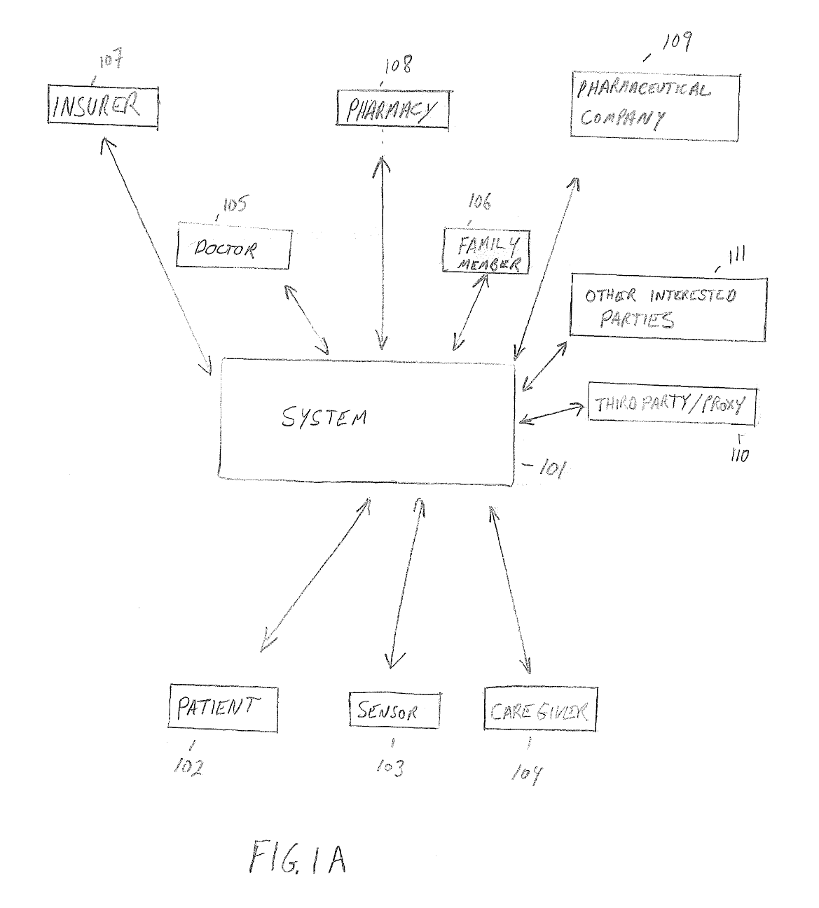

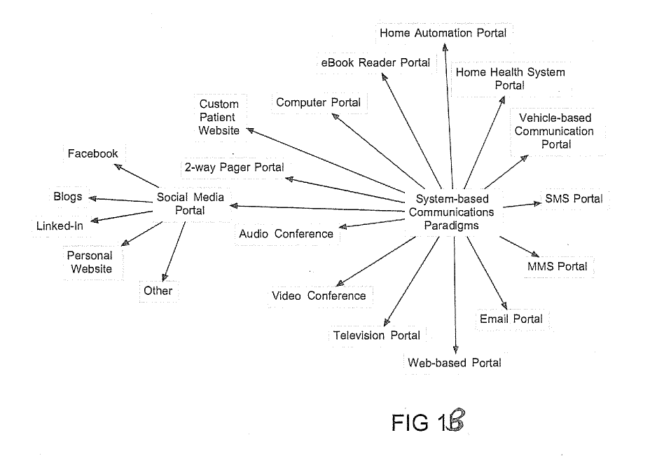

Reference is now made to FIG. 1, which is a simplified illustration of a system 101 that includes components to implement one embodiment of the present invention. Various potential users of the system 101 are shown to include a patient 102, a caregiver 104, a doctor 105, a family member 106, an insurer 107, a pharmacy 108, and a pharmaceutical company 109. For example, a patient 102, a caregiver 104 and/or a family member may use the system 101 to administer a medication compliance program for the patient 102. The doctor 105, family member 106, caregiver 104 and/or patient 102 may also use the system 101 to monitor the medication compliance of the patient 102 over time. The pharmacy 108 may use the system 101 to receive notices that the medication prescription of the patient 102 needs to be refilled and to notify the patient 102, caregiver 104 or family member 106 when the pharmacy 108 has filled a prescription that is ready for pickup or delivery. The insurer 107 and pharmaceutical company 109 may use the system 109 to analyze the medication compliance history of multiple patients 102 based on factors such as group characteristics of the patients 102 and the particular medications taken by the patients 102. The system 101 may also communicate with sensors 103 that detect whether a medication or treatment has been completed. In one embodiment, data is stored and restricted and accessed in a way that is HIPAA compliant. In one embodiment, data is stored on multiple platforms. In one embodiment, data is stored then forwarded so that data is not lost when communications systems are not available or access is limited for whatever reason.

In one embodiment, the system 100 may include a server, a network for connecting the server to other servers, a firewall, an internet connection, a secure connection to a third party SMS/MMS messaging aggregator, a secure or non-secure connection from the aggregator to cell phone carriers, a wireless connection to mobile or wireless phones, and/or optional encryption/decryption software on the wireless phones as well as standard SMS/MMS messaging on a phone. In one embodiment, web-based protocols may be used for connecting to a browser, software or API on a mobile phone. In one embodiment, connectivity to a mobile device may include a non-standard internet protocol (IP) or derivative protocol for connectivity to the mobile device. In one embodiment, the system 100 may include a cloud-based server farm. In one embodiment, the system 100 may include a combination of private and public services for connection from server to mobile devices. In one embodiment, the system 100 may consist of several parallel servers running in different areas of geographical scope for redundancy, workload balancing, or other needs including political or quasi-political reasons such as country-by-country regulations.

The system 101 may allow a patient 102, family member 106, or caregiver 104, or a third party/proxy 110 to create an account for the patient 102. The patient 102, family member 106 or caregiver 104, or any other approved interested party 111 may input the prescribed treatment information and the wireless device contact information for the patient 102. Example inputs may include the times and frequency with which the patient 102 is expected to take one or more medications or perform certain treatment-related tasks, such as taking a blood glucose reading, attending an appointment or eating food prior to taking medication. Example inputs may also include alternate methods to contact the patient 102, such as by email or to a digital pager, an alternate phone number, a landline phone, a television or mobile computer. Example inputs may also include contact information for other parties that may have an interest in the health of the patient 102, such as a family member 106 or doctor 105. In one embodiment, a computer algorithm inputs patient 102 data using one or more of (i) healthcare records of the patient 102, (ii) recommendations based on the profile of the patient 102, (iii) electronic health records, (iv) personal health records, (v) photographic images, transducers, sensors, or medical measurement devices, or (vi) any other viable source of health information.

In one embodiment, the system 101 may initially send a test message to the wireless device of the patient 102 that requests the patient 102 to reply to the message in order to verify that the system 101 is able to effectively communicate with the wireless device of the patient 102. A message may, for example, consist of a text message (SMS or MMS), email, interactive voice response, personalized video messaging, images, sound, videos, audio recordings or other messaging means commonly used with wireless devices (including, without limitation, mobile phones, smart phones, computers, laptops, tablets, PDA's, portable communication devices, home automation systems, home health systems, televisions, and in-vehicle communication devices). An application program interface (API) may also be installed on the wireless device of the patient 102. The API may serve to interface to medication and compliance data of the patient 102 with the wireless device of the patient 102. The wireless device of the patient 102 may include any commercially available wireless device and, in particular, may include handheld wireless devices and smart phones. In one embodiment, messages may be encrypted. In one embodiment, messages may be compressed. In one embodiment, messages may be unencrypted. In one embodiment, messages may be in any combination of the foregoing.

Reference is now made to FIG. 1B, which is an illustration of communication means in one embodiment of the present invention. The system 101 can communicate to the patient 101, a caregiver 104, or any interested and authorized party by a number of methods. Such methods may include applications and other programs on mobile communications devices including, among others, mobile phones, smartphones, mobile computers, PDAs, ipads, tablet computers, portable communications devices, kindle, other ebook readers, newspaper readers, home automation systems, home health systems, computerized consoles, laptop computers, desktop computers, communications devices attached to vehicles such as a car, motorcycle, bus, boat, ship, plane, helicopter, subway, and other form of ground, air, water, or space based transportation entities such as on-star, command system, in-vehicle cell phones and derivatives, in-vehicle communications devices and derivatives, in-vehicle computers, in-vehicle navigation systems including GPS, and any other in-vehicle communications devices including those that communicate data, voice, video, or other perceptible or digital information. The patient 102 may optionally set up a personal website or install on a social media site a personal API that will allow the patient 102 to communicate their compliance and health progression to specified persons or everyone. In this embodiment, the patient 102 will be able to show her goals and the progression towards those goals. The patient 102 may ask others for help and others can provide comments and advice. In one embodiment, a donations option will allow the patient 102 to tag donations to compliance or other health-related goals, in a manner similar to the way a runner ties fundraising towards miles run or a given time. Donations may be designated by the user to personal or external use including raising funds for a particular charity.

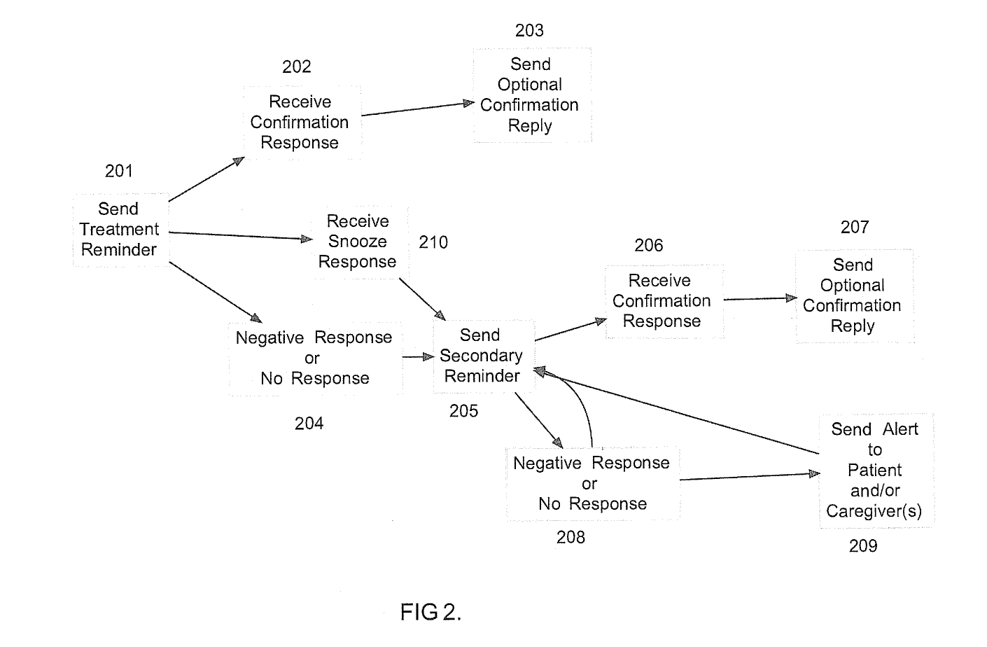

Reference is now made to FIG. 2, which is a flowchart illustrating the operation of significant functions in one embodiment of the present invention. In one embodiment, the system 101 will send a treatment reminder message 201 to the wireless device of a patient 102 to remind the patient 102 to administer a prescribed treatment. For example, the treatment reminder message 201 may notify the patient 102 or a caregiver 104 that it is time for the patient 102 to take a specific medication. In one embodiment, the treatment reminder message 201 may remind the patient 102 to take a measurement, such as blood glucose measurement, and request that the patient reply with the results of such measurement. As used herein, the terms “medication” and “prescription” may include medication, treatment, prescribed medical regimen, exercise, measurements of biologic or health data by observation, devices, consultations, or any other means of improving a person.

The treatment reminder message 201 may also request that the patient 102 or caregiver 104 respond with a confirmation message 202. For example, the system 101 may receive a confirmation response 202 from the patient 102 or caregiver 104 indicating that the prescribed treatment was administered. Upon receipt of the confirmation response 202, the system 101 may send a confirmation reply 203 to the patient 102 or caregiver 104. In one embodiment, the system may also notify others, such as a family member 106, that the confirmation response was received 202 or, alternatively, that the medication was not taken.

In one embodiment, the system 101 may receive a snooze response 210 from the patient 102 or a caregiver 014 indicating that the treatment reminder message 201 was received and will be addressed shortly. In such cases, the system 101 may wait a set amount of time before sending a second reminder 205. Similarly, the system may also receive a negative response or no response 204 in response to the treatment reminder message 201 and, in such cases, the system 101 may wait a set amount of time before sending a second reminder 205. If in response to the second reminder 205, the system 101 receives a confirmation response 206 from the patient 102 or caregiver 104 indicating that the prescribed treatment was administered, then the system 101 may send a confirmation reply 207 to the patient 102 or caregiver 104. On the other hand, if the system 101 receives a negative response or no response 208 in response to the second reminder 205, then the system 101 may send an alert 209. For example, an alert 209 may include sending additional reminder messages 201 to an alternate contact means of the patient 102 or notifying a caregiver 104 or family member 106 of the patient 102 that a confirmation message 202 or 206 has not been timely received.

It can be appreciated by one skilled in the art that the present invention also includes additional variations of the foregoing embodiment. In other embodiments, the number and order of any such reminders, responses, replies, and alerts may be varied and/or customized for a particular patient, a group of patients, and/or particular medication or treatment. For example, the system 101 may be configured to receive multiple snooze responses 210 or send multiple second reminders 205. Also, any such reminders, responses, replies, and alerts may each consist of the same messaging means or different messaging means. For example, in one embodiment, a treatment reminder message 201 could consists of a text message, a second reminder message could consists of a text message with images or video, and an alert 209 could consist of a phone call. In addition, the messaging means may be customized and/or varied for a particular patient 102, a group of patients, and/or particular medications or treatments.

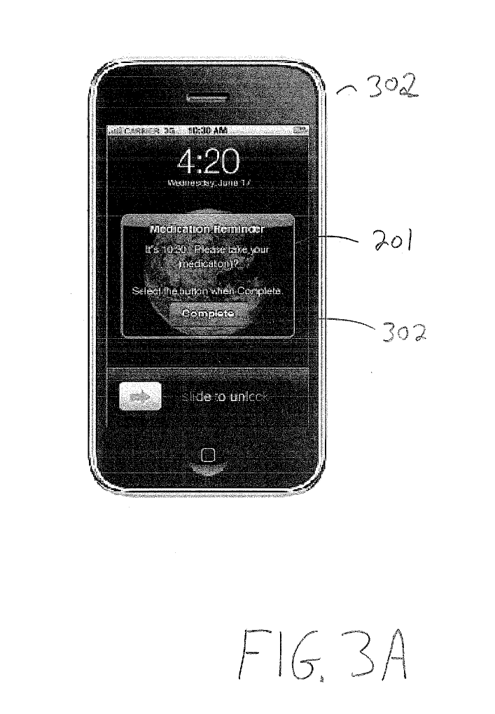

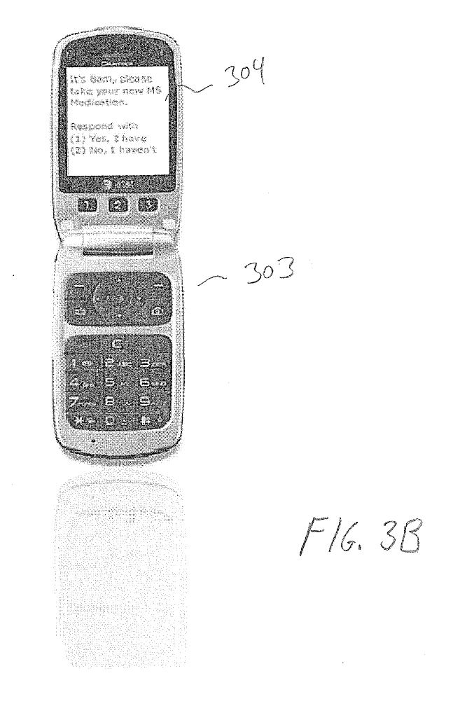

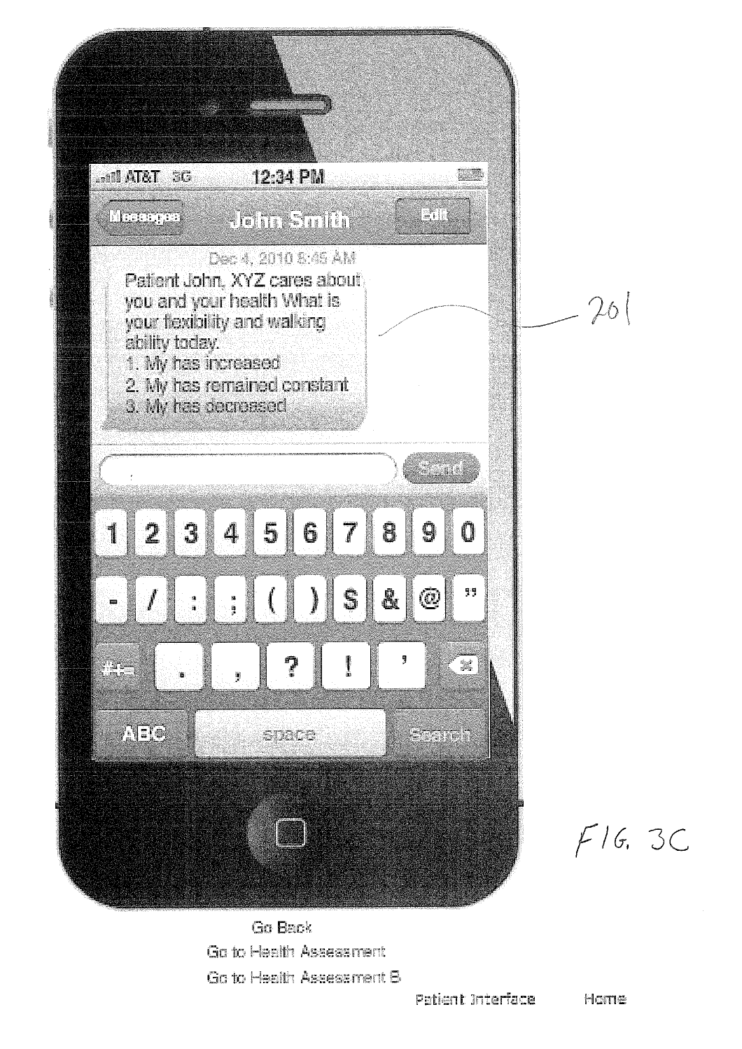

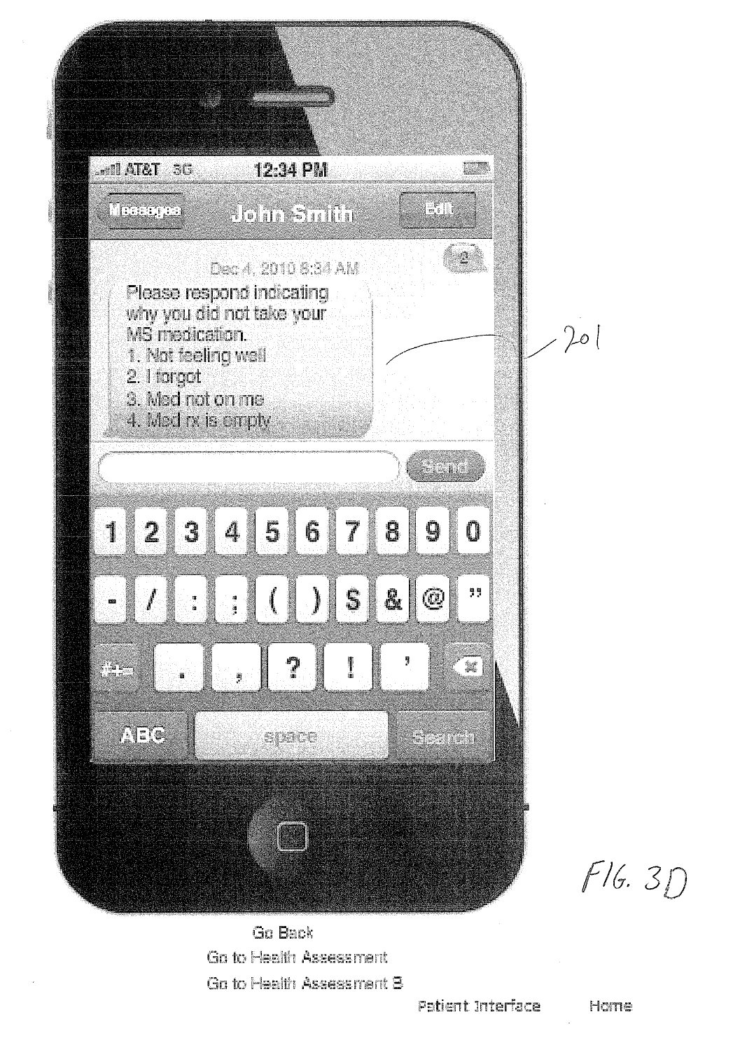

Reference is now made to FIG. 3A, which is an illustration of a treatment reminder message 201 on a smart phone 301 in one embodiment of the present invention. In this embodiment, a patient 102 has received a treatment reminder message 201 on her smart phone 301. In this example, the treatment reminder message 201 simply asks the patient 102 to “Please take your medication?” The treatment reminder message 201 also includes a reply button 302 to allow the patient 102 to easily send a confirmation response 202.

Reference is now made to FIG. 3B, which is an illustration of a second treatment reminder message on a flip-styled mobile phone 303 in one embodiment of the present invention. Communications to the patient 102 may be implemented by clear text or encrypted text to many mobile phones types where a message is sent to the user as text (SMS, MMS) 304. The patient 102 may then respond with an abbreviated response such as “1” for yes, “2” for no, “y”, “n”, or any other codification requested or understood by the patient 102. Codification of responses in this embodiment serves to distinguish messages using SMS, MMS, or other methods so that the system 101 will understand what message is being responded to. Messages may represent a plurality of medicines for which the patient can respond that they have taken them all, none, or which specific medications they have taken.

FIG. 3C is an illustration of a third treatment reminder message on a smart phone in one embodiment of the present invention. In this embodiment, a treatment reminder message 201 asks a patient 102 to respond to a question regarding the flexibility and walking ability of the patient 102. In this embodiment, the patient 102 may then respond with an abbreviated response of “1” for “increased”, “2” for “remained constant”, or “3” for “decreased”.

FIG. 3D is an illustration of a fourth treatment reminder message on a smart phone in one embodiment of the present invention. In this embodiment, a treatment reminder message 201 asks a patient 102 to respond to a question regarding why the patient 102 failed to take prescribed medication. In this embodiment, the patient 102 may then respond with an abbreviated response of “1” for “not feeling well”, “2” for “I forgot”, “3” for “Med not on me”, or “4” for “Med rx is empty”.

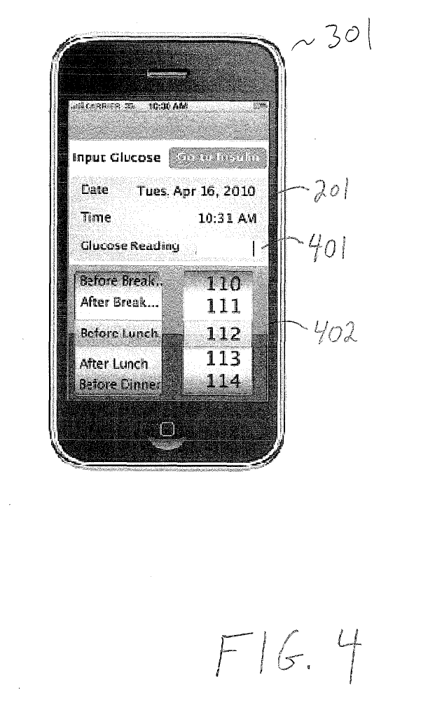

Reference is now made to FIG. 4, which is an illustration of a treatment reminder message 201 requesting that a patient 102 enter a blood glucose level in one embodiment of the present invention. In this embodiment, a patient 102 has received a treatment reminder message 201 on her smart phone 301 that is requesting the patient 102 to enter her blood glucose level. In this example, the patient 102 may type in the blood glucose level into a text box 401 or indicate the level using a scroll bar 402. The patient may also input other pertinent information, such as whether the level was measured before or after a meal, through a second scroll bar 403 or an additional text box (not shown) or other means. It can be appreciated by one skilled in the art that the treatment reminder message 201 may also be configured to address other types of treatment procedures as well. For example, the treatment reminder message 201 could remind a patient 102 to perform various rehabilitation exercises and include links to videos illustrating the recommended techniques for completing the rehabilitation exercises.

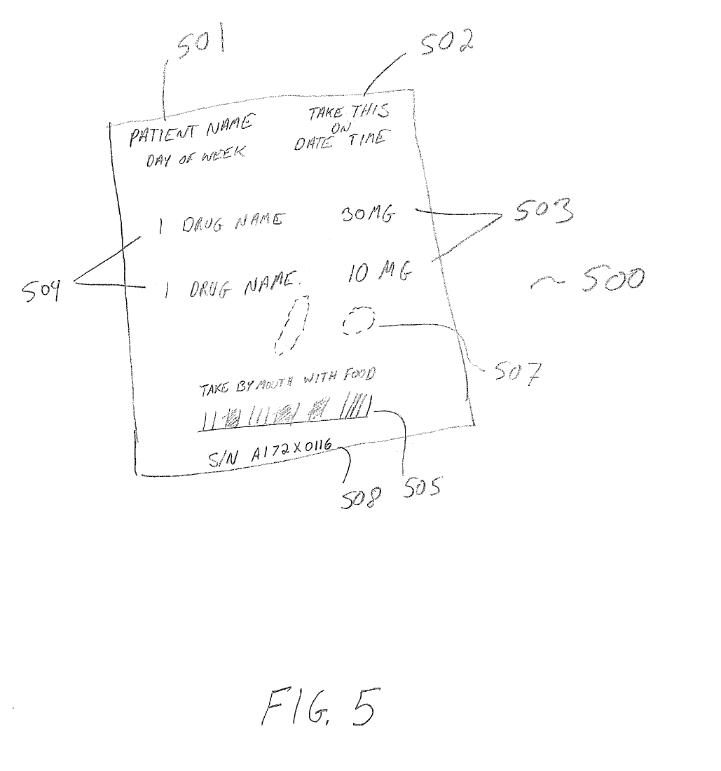

Reference is now made to FIG. 5, which is an illustration of a sealed envelope 500 containing medication 507 in one embodiment of the present invention. In this embodiment, the medication 507 can be seen inside the sealed envelope 500. In this example, one side of the sealed envelope 500, includes the name 501 of the patient 102, the date and time 502 that the patient 102 should take the medication 507, the names 504 of the medication 507, the amount 503 of the medication, the directions 506 for taking the medication 507, and a barcode 505 (which may alternatively consist of any type of barcode or means for scanning and including any illustration or electronic device such as a radio frequency identification (RFID)) and serial number 508. In one embodiment, the pharmacy 108 may prepackage the medication 507 of a patient 102 in multiple sealed envelopes 500. In other embodiments, the patient 102, a caregiver 104, or a family member 106 may package the medication 507 in the sealed envelope 500. In any event, the system 101 may be used to record some or all of the information shown on the side of the sealed envelope. For example, a caregiver 104 may record the barcode 505 and/or serial number 508 into the system 101 along with the date and time 502 that the patient 102 should take the medication 507. Then, in response to a treatment reminder message 201, the patient 102 may scan the barcode 505 and/or serial number 508 on the sealed envelope 500 as a part of a confirmation response 202. The system 101 can be used to compare the information originally recorded by the caregiver 104 to the confirmation response 102. In one embodiment, if the information does not match, the system 101 may send an alert 209 to the caregiver 104, for example, so that the caregiver 104 can confirm whether the correct medication 507 was administered.

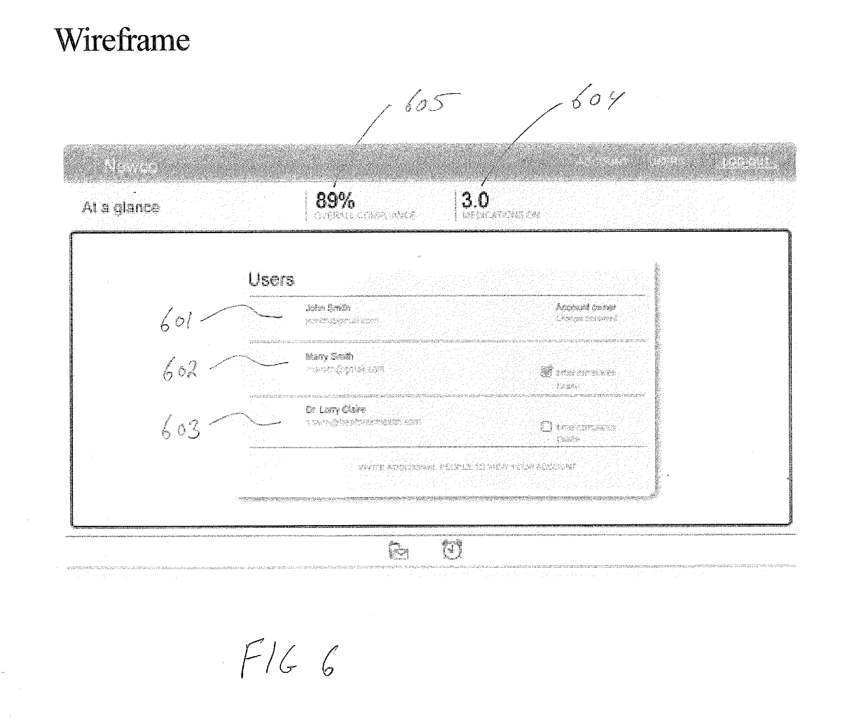

Reference is now made to FIG. 6, which is an example screen shot of a list of users in one embodiment of the present invention. In this embodiment, a family member 106 named “John Smith” is shown as the account owner 601. The account owner 601 has listed one patient 102, shown as “Mary Smith”. A doctor 105, shown as “Dr. Larry Claine” 603, is also shown to share access to the account. The example screen shot also indicates that the patient 102 is taking three medications 604 and has an overall medication compliance rate of eighty nine percent 605.

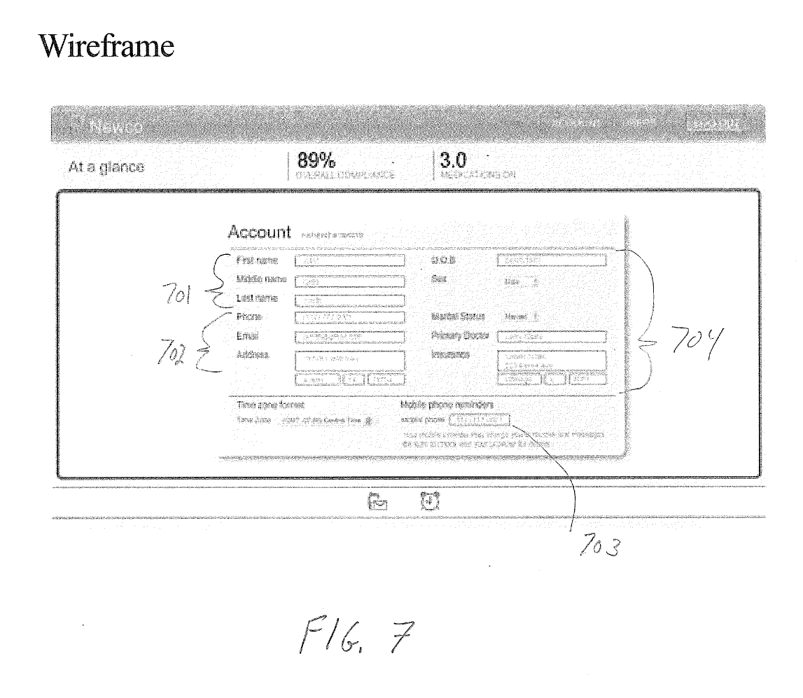

Reference is now made to FIG. 7, which is an example screen shot of a user input screen in one embodiment of the present invention. In this example screen shot, the account owner 601 has entered in his name 701, contact information 702, and mobile phone number for receiving messages from the system 101. The account owner 601 may also enter other relevant information such as medical insurance information and physician information or health history. The account owner 601, or another authorized person, may similarly input information of the patient 102 into the system 101.

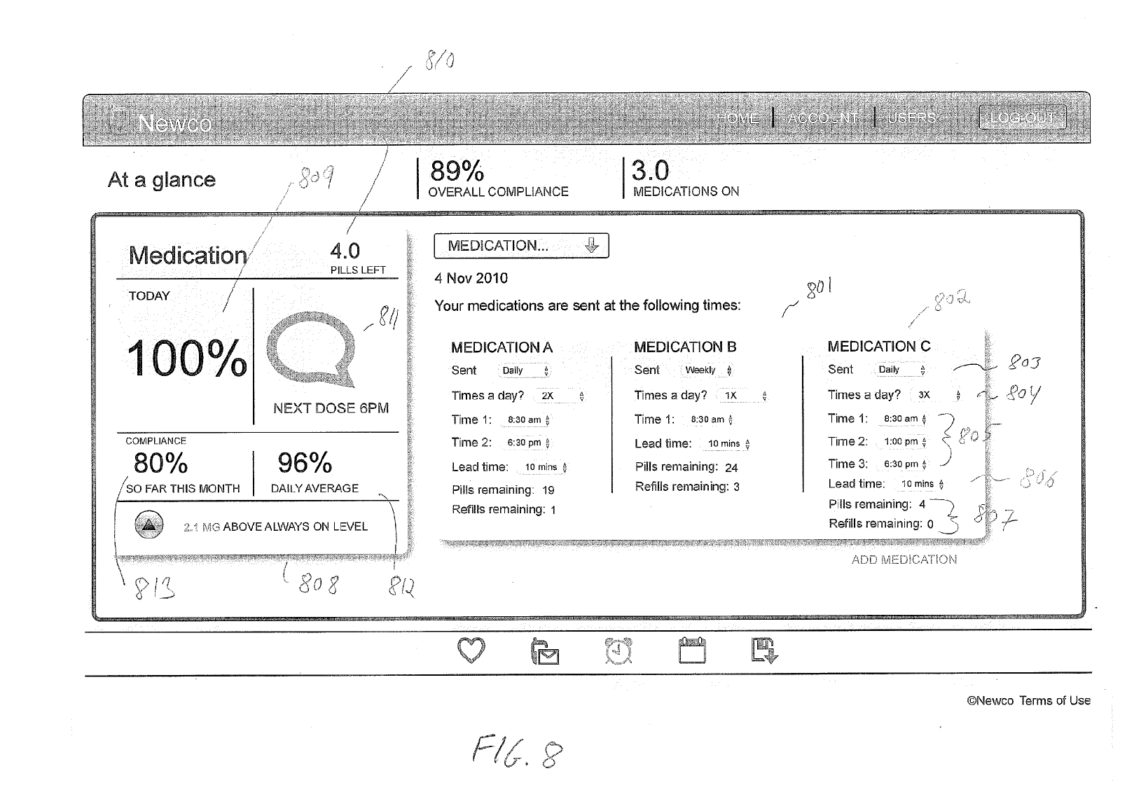

Reference is now made to FIG. 8, which is an example screen shot of a user medication profile in one embodiment of the present invention. In this example screen shot, an information panel 801 relating to each of the three medications 507 of the patient 102 is shown. For example, the information panel 801includes a sub-panel 802 for Medication C. The sub-panel indicates that for Medication C treatment reminder messages 201 are sent daily 803, three times a day 804, and at specific times 805. The sub-panel 802 also includes a lead time 806 which may be used to increase or decrease the time prior to when the medication is taken that the system 101 sends a treatment reminder message 201 and a follow up message, such as a second reminder 205. The sub-panel 802 also shows the remaining number of pills and refills remaining 807 for Medication C. In one embodiment, the system 101 may send the patient 102 an alert 209 indicating that it is time to refill a prescription based, in part, on pill count. By responding to the alert 209, the patient 102 may order, through the system 101, a refill of the prescription from the pharmacy 108. For example, once the patient 102 replies to the alert 209, the system 101 may send a request to the pharmacy 108, which may be selected by the patient 102 or other interested person, requesting the refill on behalf of the patient 102. In one embodiment, patient 102 may instruct the system 101 to pay the pharmacy 108 for the prescription refill.

Still referring to FIG. 8, the example screen shot also includes an overview panel 808. The overview panel 808 shows the medication compliance rate 809 of the patient on the present day, the number of pills left 810 in the prescription with the least number of pills remaining, the next dosage time 811, the daily average medication compliance rate 812 and the month-to-date medication compliance rate 813.

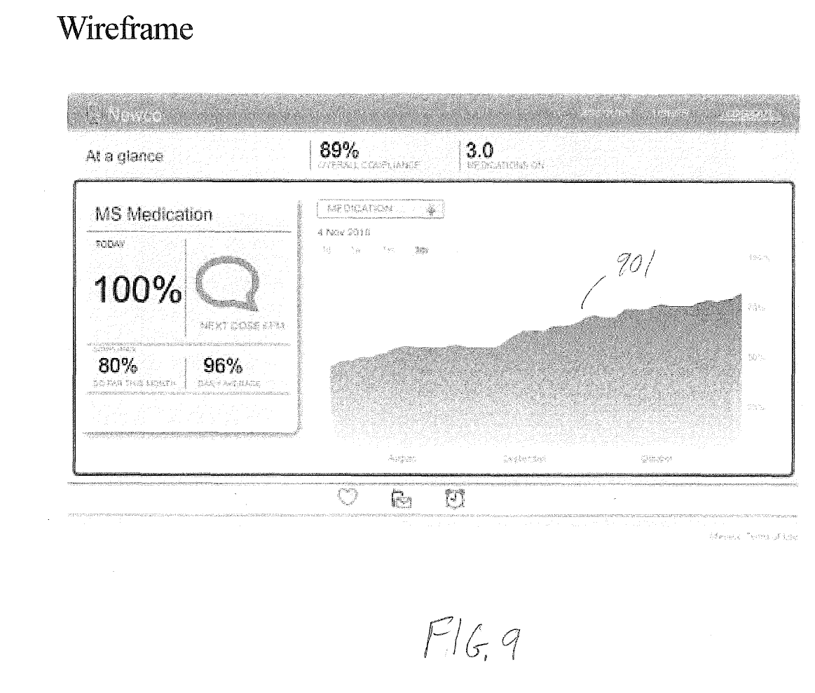

Reference is now made to FIG. 9, which is an example screen shot showing a graph of a user's medication compliance over time in one embodiment of the present invention. In this example screen shot, a graph 901 of the medication compliance rate of a patient 102 is shown to increase over time. The system 101 may similarly graphically display medication compliance rates for a given patient 102 for one or more treatments that the patient 102 is undergoing.

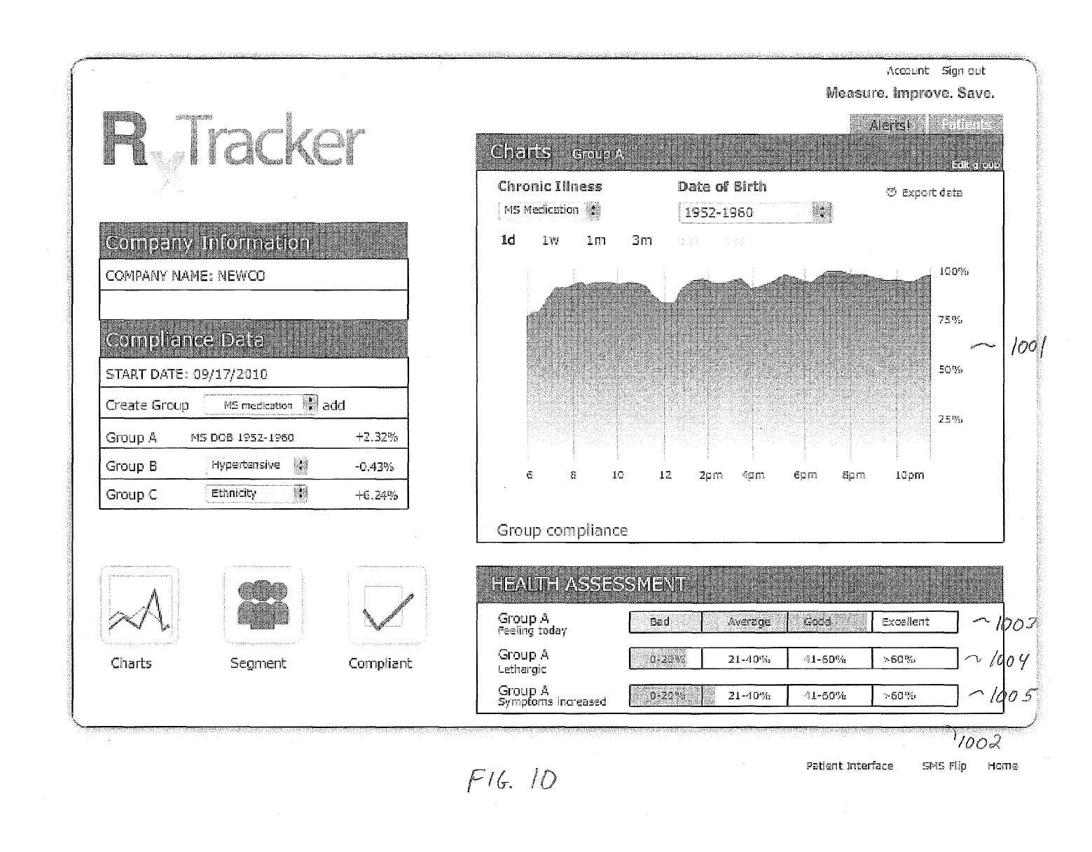

Reference is now made to FIG. 10, which is an example screen shot showing a graph of a patient group's medication compliance over time in one embodiment of the present invention. In one embodiment, the system 101 may record message information such as the time, date, and substance of the transmissions of reminder messages and/or the responses of and replies to confirmation messages. The message data may be stored on central servers, mobile communications devices, decentralized servers, a single computer or server, third party servers or any combination of the foregoing.

The message data may be compiled into an electronic health record for an individual patient 102 or compiled together with the information of multiple patients 102 in a group. In one embodiment, portions of the message data may be accessed by a patient 102, a caregiver 104, a pharmacy 108, a pharmaceutical company 109, an insurance company 107 or others having an interest in such information. For example, a doctor 105 may wish to review the electronic health record of an individual patient 102 to assess the reliability with which the patient 102 has been taking certain medications relative to other patients 102 taking the same medications. In addition, a pharmaceutical company 109 may wish to compare statistics on whether groups of patients 102 are more likely to take certain medications based on any factors such as the form or packaging of the medications. Likewise, an insurer 107 may wish to compare medication compliance rates of groups of patients 102 from different hospitals or treatment centers. In one embodiment, the data may be presented in graphical form. For example, the example screen shot shows a graph 1001 of the medication compliance rate over time for a group of patients 102 with a date of birth between 1952 and 1960 who are each taking the same medication. The system 101 has also recorded health assessment information (also referred to as health awareness information) for patients in the group. The health assessment information is shown in a table 1002 and includes an assessment of how the patient was feeling 1003, whether the patients felt lethargic 1004, and whether the patients felt that their symptoms had increased 1005. These health assessment questions can be entered and changed by an interested, authorized party causing the system to record questions and responses based, for example, on the conditions of the patient or based on the conditions normally associated with a particular medication.

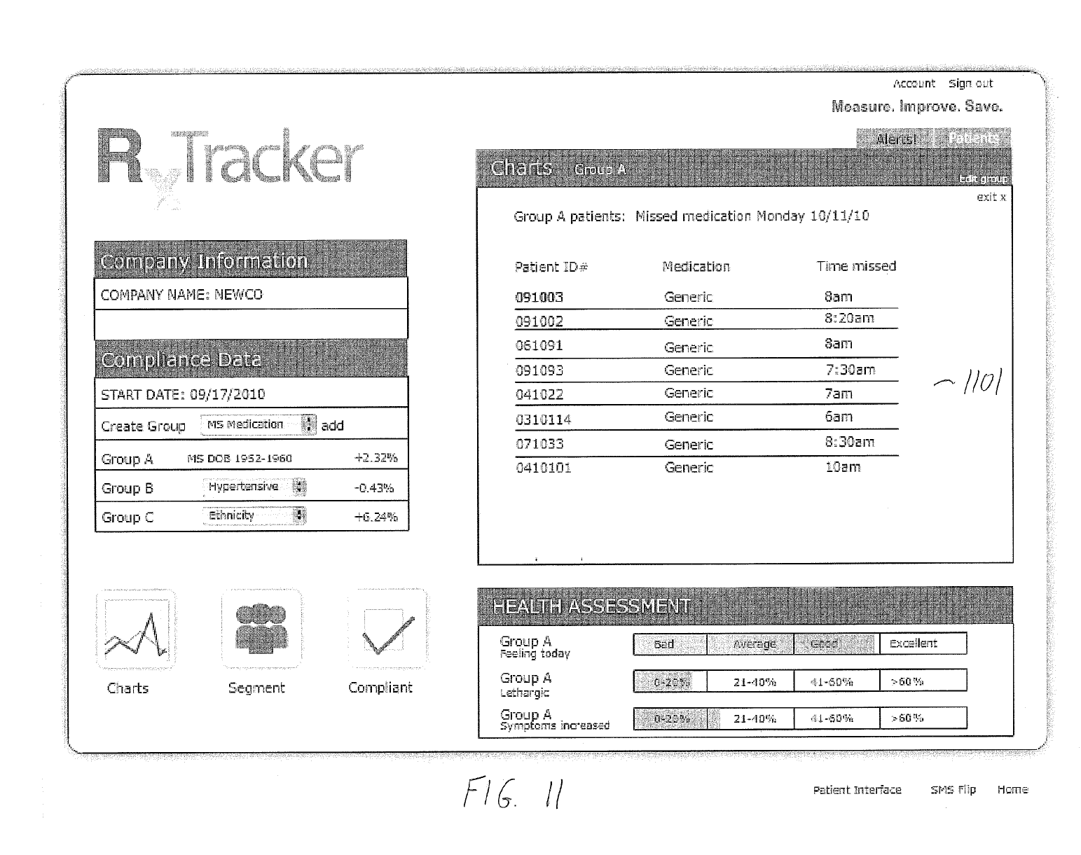

Reference is now made to FIG. 11, which is an example screen shot showing a table of a patient group's medication compliance over time in one embodiment of the present invention. In this example screen shot, medication compliance information for individual patients 102 is shown in a table 1101 without disclosing the identity of the patients 102.

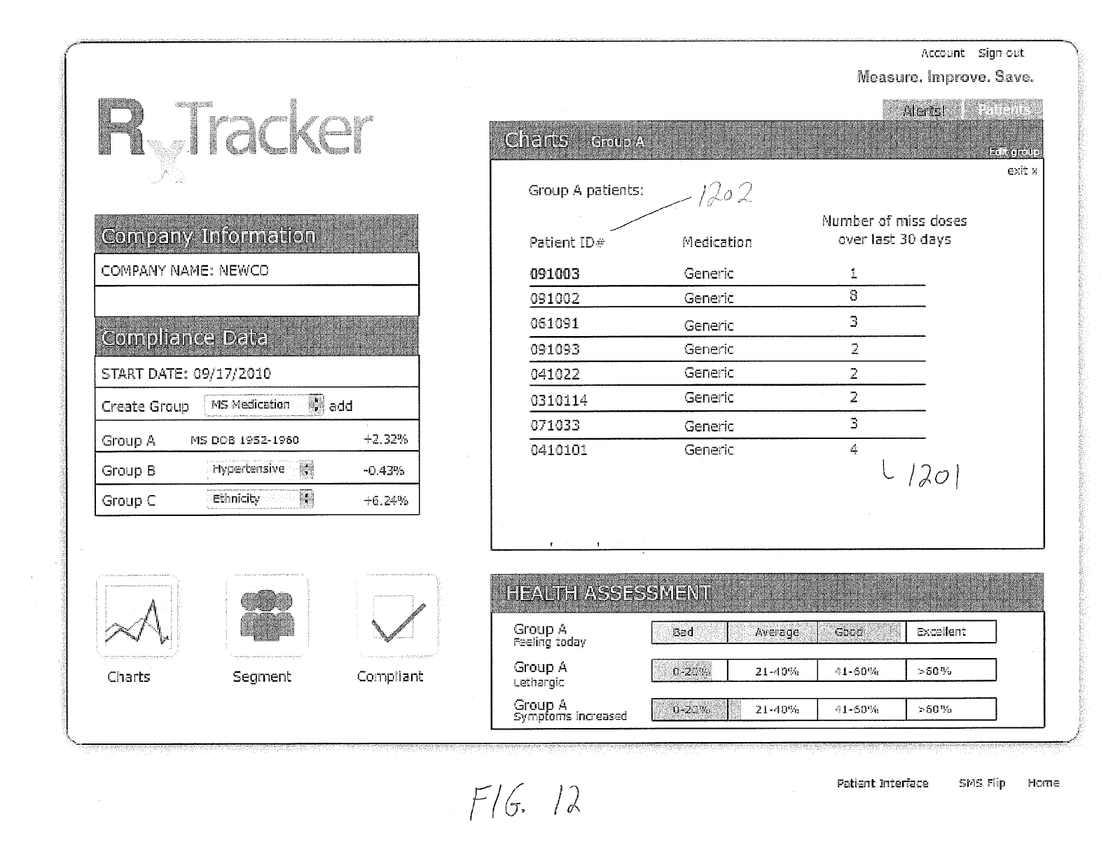

Reference is now made to FIG. 12, which is an example screen shot showing a table of a patient group's missed doses over a 30 day period in one embodiment of the present invention. In this example screen shot, a patient group's missed doses over a 30 day period are show listed by an individual Patient ID #1202 is shown in a table 1201 without disclosing the identity of the patients 102.

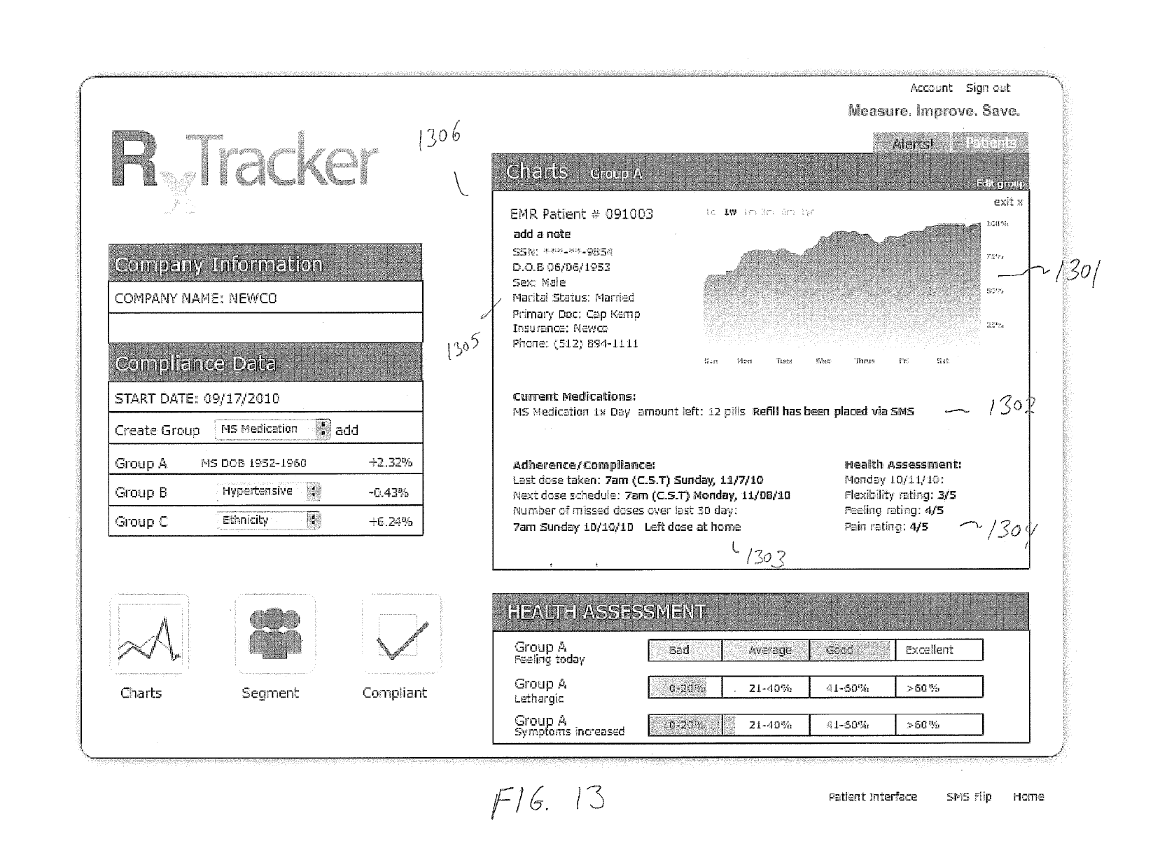

Reference is now made to FIG. 13, which is an example screen shot showing a patient's medication compliance statistics in one embodiment of the present invention. In this example screen shot, a panel 1306 shows patient background information 1305, a medication compliance graph 1301, adherence/compliance information 1303 and health assessment information 1304.

The screens illustrated in FIGS. 10, 11, 12, and 13 can be interactive allowing, for example, a click on a particular entity's information to bring up additional information on that entity. In one embodiment when a user clicks, for example, patient ID “001003” 1101 the system would bring up pertinent information for that patient as seen in FIG. 10 allowing a detailed look without releasing identifiable information on that patient 102.

In one embodiment, the system 101 may calculate a health assessment score to help assess the adherence of a patient 102 to a prescribed treatment plan. For example, the health assessment score may be comprised of recorded patient data from their electronic health record or other sources as well as from adherence data gathered by direct or indirect communication for that specific patient 102. In one example, a patient 102 who consistently takes her medication on-time, and/or refills her medications on time, will have a higher score than a patient 102 that is non-adherent or does not fill her prescriptions on time. In one embodiment, the health assessment score may include points for a patient response to a system query and reduce points for a failure to respond. For example, a patient 102 responding that she did not take her medication may be given some points—although less than a patient 102 taking her medication on time and responding—and a patient that does not respond may lose more points than a patient that responds that she hasn't taken her medication. Further, a follow up question may be generated after a negative response to taking a medication that will, based on the response, increase the health assessment score of the patient 102. For example, a follow up question may be “why didn't you take your medications” with possible response choices including: “none left”, “they don't help”, “I left them at home’, and “I no longer take that medication.” In one embodiment, the health assessment score may be increased by any or all of the following: (i) responding to queries for compliance data (for example “how is your pain today, respond with 1 for no pain, 5 for extreme pain”), (ii) taking medications on time, (iii) reporting patient specific tests and/or home monitoring and/or mobile monitoring results on a timely basis (such as insulin injections, A1C levels, blood pressure levels, lipid levels, blood chemistry, pulse rate, weight, exercise, activity levels, general well-being score, pain score, any other disease specific score), (iv) the results of patient specific tests, home monitoring data, and/or mobile monitoring results, (v) results reported by clinicians on behalf of the patient 102, (vi) results reported by third parties related to the patient 102. In one embodiment, health assessment score can be used as part of an additional score or ranking to determine, for example: (1) insurability risk, (2) health risk, (3) a predicted cost of a patient 102 as an employee or client, or (4) any other actuarial purpose.

It is appreciated that various features of the invention which are, for clarity, described in the context of separate embodiments may also be provided in combination in a single embodiment. Conversely, various features of the invention which are, for brevity, described in the context of a single embodiment may also be provided separately or in any suitable combination.

It is appreciated that any of the software components of the present invention may, generally, be implemented in firmware or hardware, if desired, using conventional techniques.

It will be appreciated by persons skilled in the art that the present invention is not limited by what has been particularly shown and described hereinabove.

All references to gender will be considered gender neutral

Any reference to patient can be construed to encompass non patients who would use a similar system

What is claimed is:

1. A system for monitoring patient medication compliance comprising:
a server configured with a medication compliance database, said medication compliance database storing: (i) a plurality of medication compliance database records representing message communications with one or more patients, (ii) prescriptions for said one or more patients, and (iii) contact information for said one or more patients; and
a messaging engine coupled to said medication compliance database, said messaging engine comprising: (a) a receiver component configured to receive messages from said one or more patients, (b) a generator component configured to generate a message to said one or more patients based on said prescriptions and said contact information; (c) a recording component configured to record generated and received messages to said medication compliance database.

2. The system of claim 1, further comprising sensors configured to generate messages that are received by said receiver component.

3. The system of claim 1, wherein said messaging engine selectively generates messages to a particular patient of said one or more patients based on the prescription for said particular patient.

4. The system of claim 1, wherein said messaging engine generates messages to a particular patient of said one or more patients based on one or more messages received or not received from said particular patient.

5. The system of claim 1, wherein said messaging engine generates an alert message to a third party based on one or more messages received or not received from a particular patient of said one or more patients.

6. A method for monitoring patient medication compliance comprising:
sending a treatment reminder message to a patient based on a prescription for said patient; and
recording in a medication compliance database whether a confirmation response message was received from said patient.

7. The method of claim 6, further comprising notifying a caregiver if said confirmation response message is not received.

8. The method of claim 6, further comprising sending one or more secondary reminder messages to said patient based on whether said confirmation response message was received from said patient.

9. The method of claim 6, further comprising recording the substance of said confirmation response message in said medication compliance database.

10. The method of claim 6, further comprising recording messages from one or more sensors configured to detect whether said patient has fulfilled a treatment.

11. A computer program embodied on a computer readable medium having instructions for monitoring patient medication compliance comprising:
sending a treatment reminder message to a patient based on a prescription for said patient; and
recording in a medication compliance database whether a confirmation response message was received from said patient.

12. The computer program recited in claim 11, further comprising notifying a caregiver if said confirmation response message is not received or a negative response is received.

13. The computer program recited in claim 11, further comprising sending one or more secondary reminder messages to said patient based on whether said confirmation response message was received from said patient.

14. The computer program recited in claim 11, further comprising recording the substance of said confirmation response message in said medication compliance database.

15. The computer program recited in claim 11, further comprising recording messages from one or more sensors configured to detect whether said patient has fulfilled a treatment.
